(19) United States
(12) Patent Application Publication
(10) Pub. No.: US 2024/0206379 A1
(43) Pub. Date: Jun. 27, 2024

(54) AGRICULTURAL SYSTEM AND METHOD FOR ADJUSTING A BASE CUTTER OF A HARVESTER

(71) Applicant: CNH Industrial Brasil Ltda., Nova Lima (BR)

(72) Inventors: Jean Carlos Pereira de Camargo, Piracicaba (BR); Marcos Ikeguchi Ohira, Piracicaba (BR); Danilo de Jesus dos Santos, Piracicaba (BR)

(21) Appl. No.: 18/392,793

(22) Filed: Dec. 21, 2023

(30) Foreign Application Priority Data
Dec. 27, 2022 (BR) 10 2022 026686 7

(51) Int. Cl. A01D 34/00; A01D 45/10; A01D 63/02

(52) U.S. Cl. CPC A01D 34/006; A01D 45/10; A01D 63/02

(57) ABSTRACT

An agricultural system includes a first row divider and a second row divider supported by a frame member relative to a surface of a field, the first and second row dividers being movable relative to the frame member and each other. The system further includes a base cutter supported by the frame member between the first and second row dividers in a lateral direction. Additionally, the system includes a computing system configured to determine a position of the first row divider relative to the frame member and a position of the second row divider relative to the frame member based on data generated by at least one divider sensor, and control an operation of a base cutter actuator to adjust a position of the base cutter relative to the surface of the field based on the positions of the first and second row dividers relative to the frame member.

### FIELD OF THE INVENTION

The present disclosure relates generally to agricultural harvesters and, more particularly, to agricultural systems and methods for adjusting a base cutter of a harvester during a harvesting operation.

### BACKGROUND OF THE INVENTION

Typically, agricultural harvesters include an assembly of processing equipment for processing harvested crop materials. For instance, a sugarcane harvester typically includes a base cutter assembly configured to sever sugarcane stalks, the severed sugarcane stalks are then conveyed via a feed roller assembly to a chopper assembly that cuts or chops the sugarcane stalks into pieces or billets (e.g., 6 inch cane sections). The processed crop material discharged from the chopper assembly is then directed as a stream of billets and debris into a primary extractor, within which the airborne debris (e.g., dust, dirt, leaves, etc.) is separated from the sugarcane billets. The separated/cleaned billets then fall into an elevator assembly for delivery to an external storage device.

During a harvesting operation with the harvester, different ground losses may occur. For instance, when the base cutter is too high, some of the harvestable stalk is left behind, which reduces the overall yield for the harvesting operation. When the base cutter is too low, the base cutter may cause the stalk to at least partially uproot and/or otherwise damage the ratoon for future growth. However, sometimes the base cutter performance is only manually evaluated after a harvesting operation is completed. Such manual evaluation is time-consuming and can only be done for a relatively small area and does not allow for losses to be evaluated and prevented during a harvesting operation.

Accordingly, an improved agricultural system and method for adjusting a base cutter of a harvester would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural system for adjusting a base cutter of an agricultural harvester. The agricultural system may include a frame member and a first row divider supported by the frame member relative to a surface of a field, with the first row divider being movable relative to the frame member. The agricultural system may similarly include a second row divider supported by the frame member relative to the surface of the field, with the second row divider being movable relative to the frame member independently of the first row divider, and with the second row divider being spaced apart from the first row divider in a lateral direction. Further, the agricultural system may include a first base cutter supported by the frame member relative to the surface of the field, where the first base cutter may be selectively movable relative to the frame member, and where the first base cutter may be positioned between the first and second row dividers in the lateral direction. Further still, the agricultural system may include a first base cutter actuator configured to selectively move the first base cutter relative to the frame member. Moreover, the agricultural system may include at least one divider sensor configured to generate data indicative of a position of the first row divider relative to the frame member and a position of the second row divider relative to the frame member. Additionally, the agricultural system may include a computing system configured to receive the data generated by the at least one divider sensor, determine the position of the first row divider relative to the frame member and the position of the second row divider relative to the frame member based at least in part on the data generated by the at least one divider sensor, and control an operation of the first base cutter actuator to adjust a position of the first base cutter relative to the surface of the field based at least in part on the position of the first row divider relative to the frame member and the position of the second row divider relative to the frame member.

In another aspect, the present subject matter is directed to an agricultural method for adjusting a base cutter of an agricultural harvester. Particularly, the agricultural harvester may include a frame member, a first row divider supported by the frame member relative to a surface of a field, and a second row divider supported by the frame member relative to the surface of the field, where the second row divider may be movable relative to the frame member independently of the first row divider. The agricultural harvester may further include a first base cutter supported by the frame member relative to the surface of the field, with the first base cutter being positioned between the first and second row dividers in a lateral direction. The method may include receiving, with a computing system, data generated by at least one divider sensor, where the data may be indicative of a position of the first row divider relative to the frame member and a position of the second row divider relative to the frame member. The method may further include determining, with the computing system, the position of the first row divider relative to the frame member and the position of the second row divider relative to the frame member based at least in part on the data. Additionally, the method may include controlling, with the computing system, an operation of a first base cutter actuator to adjust a position of the first base cutter relative to the surface of the field based at least in part on the position of the first row divider relative to the frame member and the position of the second row divider relative to the frame member.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of an agricultural harvester in accordance with aspects of the present subject matter;

FIG. 2 illustrates a front view of a front end of an agricultural harvester in accordance with aspects of the present subject matter;

FIG. 3 illustrates a section view of the front end of the agricultural harvester shown in FIG. 2, taken with respect to section line 3-3′, in accordance with aspects of the present subject matter;

FIG. 4 illustrates a schematic view of a system for adjusting a base cutter of an agricultural harvester in accordance with aspects of the present subject matter; and

FIG. 5 illustrates a flow diagram of one embodiment of a method for adjusting a base cutter of an agricultural harvester in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to agricultural systems and methods for adjusting a base cutter of an agricultural harvester, such as a sugarcane harvester. More particularly, a pair of laterally adjacent row dividers may be supported on a frame member at the front of the harvester such that the row dividers are allowed to move up and down, independently of each other, relative to the frame member as the row dividers move along a surface of the field. A base cutter may be supported on the frame member at a position laterally between the pair of row dividers such that the base cutter is selectively movable relative to the frame member by a base cutter actuator. In several embodiments, at least one sensor may be provided on the harvester, where each of the sensor(s) is configured to generate data indicative of the positions of the adjacent row dividers of the harvester relative to the frame member. For instance, a respective position sensor may be coupled between each row divider and the frame member supporting the row dividers, where the position sensors are configured to generate data indicative of the positions of the row dividers relative to the frame member. Based on the positions of the laterally adjacent row dividers relative to the frame member, the base cutter actuator may be controlled to adjust the position of the base cutter relative to the surface of the field (e.g., closer or further from the surface of the field). As such, the position of the base cutter relative to the surface of the field may be adjusted quickly to prevent losses. Further, by particularly adjusting the position of the base cutter based on the positions of both adjacent row dividers, the surface of the field at the lateral position of the base cutter may be more closely followed by the base cutter. In some instances, a feedback sensor is also provided that generates feedback data indicative of the position of the base cutter relative to the frame, which, may be used to ensure that the base cutter actuator is properly calibrated and that the base cutter is moved into the desired position.

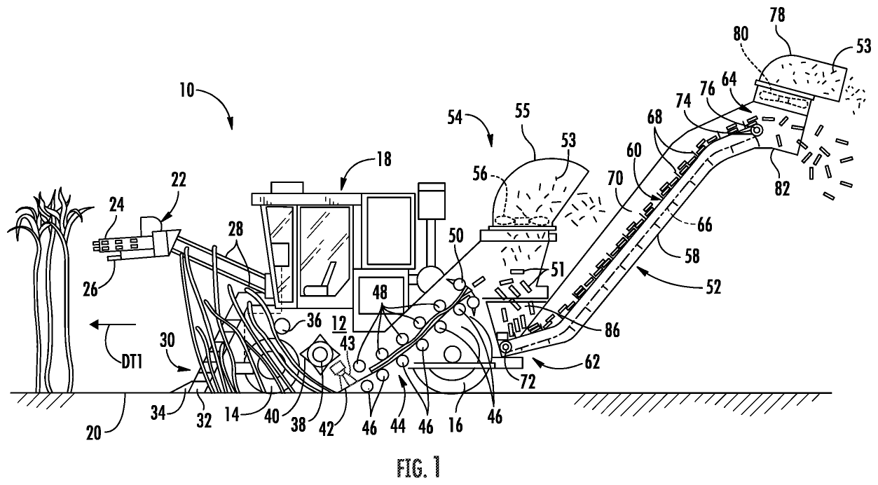

Referring now to the drawings, FIG. 1 illustrates a side view of one embodiment of an agricultural harvester 10 in accordance with aspects of the present subject matter. As shown, the harvester 10 is configured as a sugarcane harvester. However, in other embodiments, the harvester 10 may correspond to any other suitable agricultural harvester known in the art.

As shown in FIG. 1, the harvester 10 includes a frame 12, a pair of front wheels 14, a pair of rear wheels 16, and an operator's cab 18. The harvester 10 may also include a primary source of power (e.g., an engine mounted on the frame 12) which powers one or both pairs of the wheels 14, 16 via a transmission (not shown). Alternatively, the harvester 10 may be a track-driven harvester and, thus, may include tracks driven by the engine as opposed to the illustrated wheels 14, 16. The engine may also drive a hydraulic fluid pump (not shown) configured to generate pressurized hydraulic fluid for powering various hydraulic components of the harvester 10.

The harvester 10 may include various components for cutting, processing, cleaning, and discharging sugarcane as the cane is harvested from an agricultural field 20. For instance, during operation, the harvester 10 is traversed across an agricultural field 20 for harvesting crop, such as sugarcane. The harvester 10 may include a topper assembly 22 positioned at its front end to intercept sugarcane as the harvester 10 is moved in the forward direction. As shown, the topper assembly 22 may include both a gathering disk 24 and a cutting disk 26. The gathering disk 24 may be configured to gather the sugarcane stalks so that the cutting disk 26 may be used to cut off the top of each stalk. As is generally understood, the height of the topper assembly 22 may be adjustable via a pair of arms 28 hydraulically raised and lowered, as desired, by the operator. After the height of the topper assembly 22 is adjusted via the arms 28, the gathering disk 24 on the topper assembly 22 may function to gather the sugarcane stalks as the harvester 10 proceeds across the field 20, while the cutter disk 26 severs the leafy tops of the sugarcane stalks for disposal along either side of harvester 10.

The harvester 10 may further include a crop divider 30 that extends upwardly and rearwardly from the field 20. In general, the crop divider 30 may include two spiral feed rollers 32. Each feed roller 32 may include a ground shoe 34 at its lower end to assist the crop divider 30 in gathering the sugarcane stalks for harvesting. As the stalks enter the crop divider 30, the ground shoes 34 may set the operating width to determine the quantity of sugarcane entering the throat of the harvester 10. The spiral feed rollers 32 then gather the stalks into the throat to allow a knock-down roller 36 to bend the stalks downwardly in conjunction with the action of a fin roller 38. The knock-down roller 36 is positioned near the front wheels 14 and the fin roller 38 positioned behind or downstream of the knock-down roller 36. As the knock-down roller 36 is rotated, the sugarcane stalks being harvested are knocked down. The fin roller 38 may include a plurality of intermittently mounted fins 40 that assist in forcing the sugarcane stalks downwardly. For instance, as the fin roller 38 is rotated, the sugarcane stalks that have been knocked down by the knock-down roller 36 are separated and further knocked down by the fin roller 38 as the harvester 10 continues to be moved in the forward direction relative to the field 20.

Once the stalks are angled downwardly as shown in FIG. 1, a base cutter 42 may then sever the base of the stalks from field 20. The base cutter 42 is positioned behind or downstream of the fin roller 38. As is generally understood, the base cutter 42 may include knives or blades 43 for severing the sugarcane stalks as the cane is being harvested. The blades 43, located on the periphery of the base cutter 42, may be rotated by a hydraulic motor (not shown) powered by the vehicle's hydraulic system. Moreover, in several embodiments, the blades may be angled downwardly to sever the base of the sugarcane as the cane is knocked down by the fin roller 38. Additionally, the height of the base cutter 42 (e.g., of the blades 43) above the field 20 may be adjustable. For instance, as will be described below in greater detail, it is preferable to sever the sugarcane stalks at or below a particular cutting height above the field 20 such that the maximum amount of sugarcane is harvested during the current harvesting operation and such that the remaining ratoons may regrow during the next growing season. As such, the vertical height of the base cutter 42 may be adjustable to maintain the cutting height for harvesting the sugarcane at or below the particular cutting height.

The severed stalks are then, by movement of the harvester 10, directed to a feed roller assembly 44 located downstream of the base cutter 42 for moving the severed stalks of sugarcane from base cutter 42 along the processing path. As shown in FIG. 1, the feed roller assembly 44 may include a plurality of bottom rollers 46 and a plurality of opposed, top pinch rollers 48. The harvested sugarcane may be pinched between various bottom and top rollers 46, 48 to make the sugarcane stalks more uniform and to convey the harvested sugarcane rearwardly (downstream) during transport. As the sugarcane is transported through the feed roller assembly 44, debris (e.g., rocks, dirt, and/or the like) may be allowed to fall through bottom rollers 46 onto the field 20.

At the downstream end of the feed roller assembly 44 (e.g., adjacent to the rearward-most bottom and top rollers 46, 48), a chopper assembly 50 may cut or chop the compressed sugarcane stalks. In general, the chopper assembly 50 may be used to cut the sugarcane stalks into pieces or “billets” 51, which may be, for example, six (6) inches long. The billets 51 may then be propelled towards an elevator assembly 52 of the harvester 10 for delivery to an external receiver or storage device (not shown).

As is generally understood, a primary extractor assembly 54 may be provided to help separate pieces of debris 53 (e.g., dust, dirt, leaves, etc.) from the sugarcane billets 51 before the billets 51 are received by the elevator assembly 52. The primary extractor assembly 54 is located immediately behind or downstream of the chopper assembly 50 relative to the flow of harvested crop and is oriented to direct the debris 53 outwardly from the harvester 10. The primary extractor assembly 54 may include an extractor fan 56 mounted within a housing 55 for generating a suction force or vacuum sufficient to separate and force the debris 53 through an inlet of the housing 55 into the primary extractor assembly 54 and out of the harvester 10 via an outlet of the housing 55. The separated or cleaned billets 51 are heavier than the debris 53 being expelled through the extractor 54, so the billets 51 may fall downward to the elevator assembly 52 instead of being pulled through the primary extractor assembly 54.

As further shown in FIG. 1, the elevator assembly 52 may include an elevator housing 58 and an elevator 60 extending within the elevator housing 58 between a lower, proximal end 62 and an upper, distal end 64. In general, the elevator 60 may include a looped chain 66 and a plurality of flights or paddles 68 attached to and evenly spaced on the chain 66. The paddles 68 may be configured to hold the sugarcane billets 51 on the elevator 60 as the billets are elevated along a top span of the elevator 70 defined between its proximal and distal ends 62, 64. Additionally, the elevator 60 may include lower and upper sprockets 72, 74 positioned at its proximal and distal ends 62, 64, respectively. As shown in FIG. 1, an elevator motor 76 may be coupled to one of the sprockets (e.g., the upper sprocket 74) for driving the chain 66, thereby allowing the chain 66 and the paddles 68 to travel in an endless loop between the proximal and distal ends 62, 64 of the elevator 60.

Additionally, in some embodiments, pieces of debris or trash 53 (e.g., dust, dirt, leaves, etc.) separated from the elevated sugarcane billets 51 may be expelled from the harvester 10 through a secondary extractor assembly 78 coupled to the rear end of the elevator housing 58. For example, the debris 53 expelled by the secondary extractor assembly 78 may be debris remaining after the billets 51 are cleaned and debris 53 expelled by the primary extractor assembly 54. As shown in FIG. 1, the secondary extractor assembly 78 may be located adjacent to the distal end 64 of the elevator 60 and may be oriented to direct the debris 53 outwardly from the harvester 10. Additionally, an extractor fan 80 may be mounted at the base of the secondary extractor assembly 78 for generating a suction force or vacuum sufficient to pick up the debris 53 and force the debris 53 through the secondary extractor assembly 78. The separated, cleaned billets 51, heavier than the debris 53 expelled through the extractor 78, may then fall from the distal end 64 of the elevator 60. Typically, the billets 51 may fall downwardly through an elevator discharge opening 82 of the elevator assembly 52 into an external storage device (not shown), such as a sugarcane billet cart.

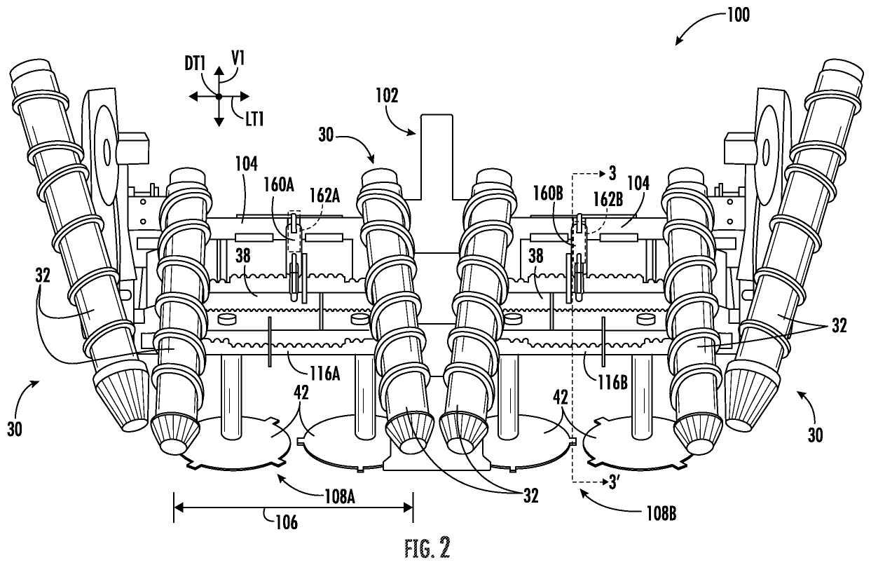

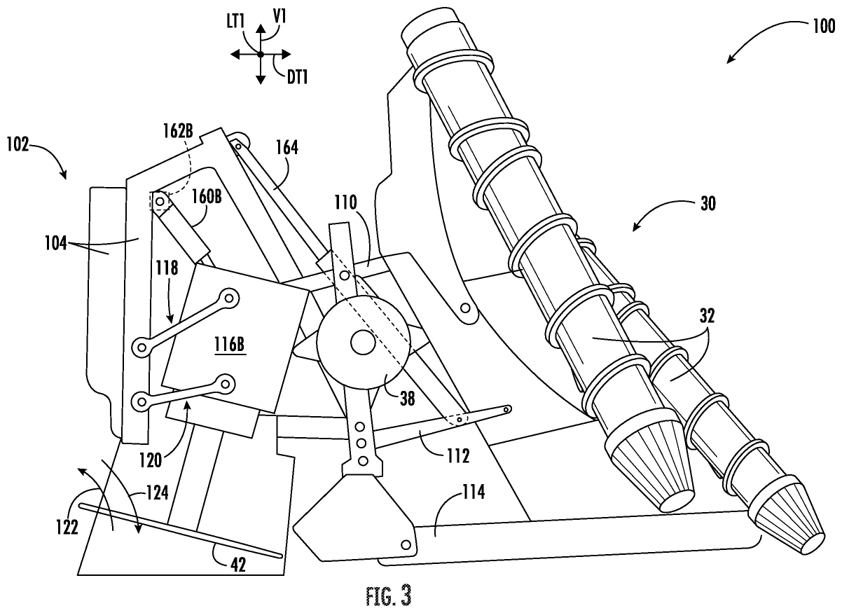

Referring now to FIGS. 2 and 3, various views of a front end 100 suitable for use with a harvester, such as the harvester 10, are illustrated in accordance with aspects of the present subject matter. Particularly, FIG. 2 illustrates a front view of the front end 100 of the harvester 10, with the finned rollers 38 being shown transparently and with the blades 43 of the base cutters 42 being removed for example purposes. Additionally, FIG. 3 illustrates a section view of the front end 100 of the harvester 10, taken with respect to section line 3-3′ in FIG. 2, with the blades 43 of the base cutters 42 being removed for example purposes.

As particularly shown in FIGS. 2 and 3, the front end 100 includes a forward frame 102 including a frame member 104, where the frame member 104 may be supported on the chassis or frame 12 (FIG. 1) of the harvester 10. In some embodiments, the frame member 104 is fixed relative to the frame 12 (FIG. 1) of the harvester 10. However, in other embodiments, the frame member 104 may be movable relative to the frame 12 (FIG. 1) of the harvester 10. The frame member 104 may generally support the various components of the harvester 10 relative to the frame 12 (FIG. 1). For instance, each of the crop dividers 30 may be movably coupled at the forward end of the frame member 104 relative to the direction of travel DT1. For example, each of the crop dividers 30 may be supported by a respective linkage assembly including a first link 110 and a second link 112 relative to the frame member 104, as shown in FIG. 3. As such, the crop dividers 30 may move up and down in a vertical direction V1 relative to the frame member 104, independently of each other, as a shoe member 114 of each divider 30 moves along the surface of the field. Further, as shown in FIG. 2, adjacent crop dividers 30 are spaced apart along a lateral direction LT1 of the harvester 10 by a distance 106 to define lateral flow regions through which crop is directed towards the base cutters 42. For example, as shown in FIG. 2, a first lateral flow region 108A is defined between the left and center crop dividers 30 and a second lateral flow region 108B is defined between the center and right crop dividers 30. It should be appreciated that, while the front end 100 is shown as including three crop dividers 30, the front end 100 may include any other suitable number of crop dividers 30, such as two, four, or more crop dividers 30, such that one, three, or more flow regions are instead defined by the crop dividers 30. Similarly, it should be appreciated that, while each crop divider 30 is shown as having two spiral rollers 32, any other suitable number of spiral rollers 32 for each crop divider 30 may instead be provided, such as one, three, or more spiral rollers 32 per crop divider 30.

The finned rollers 38 and the base cutters 42 may also be supported relative to the frame member 104, within the flow regions 108A, 108B, with the finned rollers 38 being generally positioned forward of the base cutters 42 relative to the direction of travel DT1 and rearward of the dividers 30 relative to the direction of travel DT1. For instance, as shown in FIG. 2, the base cutters 42 in the first lateral flow region 108A are coupled to a first lateral support bar 116A and the base cutters 42 in the second lateral flow region 108B are coupled to a second lateral support bar 116B. Each of the lateral support bars 116A, 116B may be movably coupled to the frame member 104, independently of each other. For example, each of the lateral support bars 116A, 116B is movably coupled to the frame member 104 by a respective linkage assembly including a first link 118 and a second link 120, as shown in FIG. 3. As such, the lateral support bars 116A, 116B (and the corresponding base cutters 42) are movable in a first direction 122 relative to the frame member 104, further from the surface of the field in the vertical direction V1, and in a second, opposite direction 124 relative to the frame member 104, closer to the surface of the field in the vertical direction V1.

As shown in FIG. 2, a first base cutter actuator 160A is coupled between the frame member 104 and the first lateral support bar 116A to selectively move the first lateral support bar 116A relative to the frame member 104. Similarly, a second base cutter actuator 160B is coupled between the frame member 104 and the second lateral support bar 116B to selectively move the second lateral support bar 116B relative to the frame member 104, independently of actuation of the first lateral support bar 116A by the first base cutter actuator 160A. In the illustrated embodiments, the base cutter actuators 160A, 160B are linear actuators (e.g., electric linear actuators, hydraulic linear actuators, and/or the like). However, it should be appreciated that, in other embodiments, the base cutter actuators 160A, 160B may instead be rotary actuators. In some instances, each of the base cutter actuators 160A, 160B is configured as an electro-hydraulic feedback actuator, having a feedback sensor 162A, 162B integrated therein, with the feedback sensors 162A, 162B being configured to generate data indicative of movement of the base cutter actuators 160A, 160B, which is, in turn, indicative of the positions of the base cutters 42 relative to the surface of the field. However, it should be appreciated that, in some embodiments, the feedback sensor 162A, 162B may instead, or additionally, be provided separate of the base cutter actuators 160A, 160B, such that the feedback sensors 162A, 162B generate data indicative of movement of the lateral support bars 116A, 116B, which is, in turn, indicative of the positions of the base cutters 42 relative to the surface of the field. The feedback sensors 162A, 162B may be any suitable type of position sensor, such as a linear position sensor (e.g., linear transducers, and/or the like) or an angular position sensor (e.g., a rotary potentiometer, rotary encoder, and/or the like).

It is important to maintain the base cutters 42 at a desired position or height relative to the surface of the field in the vertical direction V1 throughout a harvesting operation. For instance, when the base cutters 42 are too high relative to the surface of the field, some of the harvestable stalk is left behind, which reduces the overall yield for the harvesting operation. When the base cutters 42 are too low relative to the field, the base cutters 42 may cause the stalk to at least partially uproot and/or otherwise damage the ratoon for future growth. However, the surface of the field may vary significantly across the lateral width of the harvester 10 in the lateral direction LT1.

Thus, in accordance with aspects of the present subject matter, at least one row divider sensor 164 may be provided that generates data indicative of the positions of the row dividers 30 relative to the frame member 104 which, in turn, are indicative of the contour of the surface of the field. For instance, a respective row divider sensor 164 may be coupled between each of the row dividers 30 and the frame member 104, such as between the second link 112 and frame member 104, only one of the row divider sensors 164 being shown in FIG. 3. In some embodiments, the row divider sensors 164 comprise linear position sensors (e.g., linear transducers, and/or the like) or angular position sensors (e.g., a rotary potentiometer, rotary encoder, and/or the like) such that displacement of the sensor(s) 164 is indicative of the position(s) of the row divider(s) 30. However, in one embodiment, the row divider sensor(s) 164 may be configured as an optical sensor (e.g., a camera, a Hall-effect sensor, a radio detection and ranging (RADAR) sensor, a light detection and ranging (LIDAR) sensor, and/or the like) having a field of view directed towards one or more of the row dividers 30 to generate data indicative of the position(s) of the row divider(s) 30 relative to the frame member 104.

As will be described in greater detail below, the base cutter actuators 160A, 160B may be controlled based at least in part on the positions of the row dividers 30 relative to the frame member 104. For instance, the first base cutter actuator 160A may be controlled to adjust the position of the first lateral support bar 116A relative to the frame member 104, and thus, the position of the base cutters 42 within the first lateral flow region 108A relative to the surface of the field, based at least in part on the positions of the directly adjacent row dividers 30 associated with the first lateral flow region 108A (e.g., the left row divider 30 and the center row divider 30 in FIG. 2). Similarly, the second base cutter actuator 160B may be controlled to adjust the position of the second lateral support bar 116B relative to the frame member 104, and thus, the position of the base cutters 42 within the second lateral flow region 108B relative to the surface of the field, based at least in part on the positions of the directly adjacent row dividers 30 associated with the second lateral flow region 108B (e.g., the center row divider 30 and the right row divider 30 in FIG. 2). Generally, the base cutter actuators 160A, 160B are controlled to raise the base cutters 42 when the corresponding row dividers 30 are raised relative to the frame member 104 in the vertical direction V1 and conversely, the base cutter actuators 160A, 160B are controlled to lower the base cutters 42 when the corresponding row dividers 30 are lowered relative to the frame member 104 in the vertical direction V1.

In some instances, an average of the positions of the row dividers 30 relative to the frame member 104 for a given flow region 108A, 108B is used to control the respective base cutter actuator 160A, 160B. For instance, the first base cutter actuator 160A may be controlled based on an average of the positions of the left and center row dividers 30 relative to the frame member 104 and the second base cutter actuator 160B may be controlled based on an average of the positions of the center and right row dividers 30 relative to the frame member 104. As such, the positions of the base cutters 42 may be adjusted automatically based on the height of the field at the lateral position of base cutters 42.

Referring now to FIG. 4, a schematic view of a system 200 for automatically adjusting a base cutter of an agricultural harvester is illustrated in accordance with aspects of the present subject matter. In general, the system 200 will be described with reference to the agricultural harvester 10 described with reference to FIGS. 1-3. However, it should be appreciated that the disclosed system 200 may be implemented with harvesters having any other suitable configurations.

In several embodiments, the system 200 may include one or more computing systems 202 and various other components configured to be communicatively coupled to and/or controlled by the computing system(s) 202, such as the base cutter actuator(s) 160A, 160B, the feedback sensor(s) 162A, 162B, the row divider sensor(s) 164, one or more positioning sensor(s) 170, and/or one or more user interfaces 180. The user interface(s) 180 described herein may include, without limitation, any combination of input and/or output devices that allow an operator to provide inputs to the computing system 202 and/or that allow the computing system 202 to provide feedback to the operator, such as a keyboard, keypad, pointing device, buttons, knobs, touch sensitive screen, mobile device, audio input device, audio output device, and/or the like.

In general, the computing system(s) 202 may correspond to any suitable processor-based device(s), such as a computing device or any combination of computing devices. Thus, as shown in FIG. 4, the computing system(s) 202 may generally include one or more processor(s) 204 and associated memory devices 206 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 206 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 206 may generally be configured to store information accessible to the processor(s) 204, including data 208 that can be retrieved, manipulated, created and/or stored by the processor(s) 204 and instructions 212 that can be executed by the processor(s) 204.

In several embodiments, the data 208 may be stored in one or more databases. For example, the memory 206 may include a sensor database 210 for storing data received from the sensor(s) 162A, 162B, 164. For instance, the sensor(s) 162A, 162B, 164 may be configured to continuously or periodically capture data associated with the positioning of the base cutters 42 and row dividers 30. For instance, as discussed above, the sensor(s) 162A, 162B, 164 may be associated with the harvester 10 configured to perform a harvesting operation within the field 20. Particularly, the feedback sensor(s) 162A, 162B are configured to generate data 210 indicative of the position of the associated base cutters 42 relative to the frame member 104, which, in turn is indicative of the position of the associated base cutters 42 relative to the surface of the field. The row divider sensor(s) 164 are configured to generate data 210 indicative of the positions of the row dividers 30 relative to the frame member 104. In such an embodiment, the data generated by the sensor(s) 162A, 162B, 164 may be transmitted to the computing system(s) 202 and stored within the sensor database 210 for subsequent processing and/or analysis. It should be appreciated that, as used herein, the term “data” may include any suitable type of data received from the sensor(s) 162A, 162B, 164 that allows for the relative positionings of the base cutters 42 and the row dividers 30 relative to the frame member 104, to be analyzed and/or estimated, as will be described in greater detail below.

It should be appreciated that the sensor data 210 may be geo-referenced or may otherwise be stored with corresponding location data associated with the specific location at which such data was collected within the field. In one embodiment, the sensor data 210 may be correlated to a corresponding position within the field based on location data received from the positioning sensor(s) 170, which may include a Global Positioning System (GPS) or another similar positioning device(s), configured to transmit a location corresponding to a position of the harvester 10 within the field when the data 210 is collected by the sensor(s) 162A, 162B, 164. As such, the contour of the surface of the field may be mapped based at least in part on the data 210 collected by the sensor(s) 162A, 162B, 164 for subsequent field operations and/or analysis.

Referring still to FIG. 4, in several embodiments, the instructions 212 stored within the memory 206 of the computing system(s) 202 may be executed by the processor(s) 204 to implement a control module 214. In general, the control module 214 may be configured to analyze the sensor data 210 deriving from the row divider sensor(s) 164 to determine the contour of the surface of the field. For instance, as indicated above, the data 210 from the row divider sensor(s) 164 may include data indicative of the position of the row dividers 30 relative to the frame member 104, which, in turn, is indicative of changes in the contour of the surface of the field. The computing system(s) 202 (e.g., the control module 214) may be configured to analyze the sensor data 210 from the row divider sensor(s) 164 using any suitable relationships, algorithms, and/or processing techniques (e.g., image processing techniques) to determine the positions of the row dividers 30 relative to the frame member 104. The computing system(s) 202 (e.g., the control module 214) may be configured to similarly analyze the sensor data 210 from the feedback sensor(s) 162A, 162B to determine the positions of the base cutters 42 relative to the frame member 104, and thus, the positions of the base cutters 42 relative to the surface of the field.

The control module 214 may be configured to automatically initiate a control action in response to the positions of the row dividers 30 relative to the frame member 104. For instance, the control action may include controlling an operation of the base cutter actuator(s) 160A, 160B based on the positions of the associated row dividers 30.

For example, as indicated above, the control module 214 may control the first base cutter actuator 160A based at least in part on the positions of the left and center row dividers 30 relative to the frame member 104. Particularly, the control module 214 may monitor the changes in the positions of the left and center row dividers 30 relative to the frame member 104, which are indicative of changes in a contour of the surface of the field. The control module 214 may then determine a corresponding requested change in the position of the base cutters 42 supported on the first lateral support bar 116A based on the changes in the positions of the left and center row dividers 30. In some instances, for example, the control module 214 may determine an average between the change in position of the left row divider 30 and the change in position of the central row divider 30. Then, the control module 214 may control the first base cutter actuator 160A to adjust the position of the base cutters 42 relative to the frame member 104 by a first amount that corresponds to such average, the first amount being determined using any suitable relationships (e.g., look up table(s)), algorithms, and/or the like. Thereafter, the control module 214 may monitor the change in the position of the base cutters 42 on the first lateral support bar 116A based at least in part on the data from the feedback sensor 162A to determine whether the base cutters 42 on the first lateral support bar 116A have moved by the requested first amount. If the change in the position of the base cutters 42 on the first lateral support bar 116A does not correspond to the first amount (or within a certain threshold of the first amount), then the control module 214 may generate a warning indicating a problem with the first base cutter actuator 160A.

Similarly, as indicated above, the control module 214 may control the second base cutter actuator 160B based at least in part on the positions of the center and right row dividers 30 relative to the frame member 104. Particularly, the control module 214 may monitor the changes in the positions of the center and right row dividers 30 relative to the frame member 104, which are indicative of changes in a contour of the surface of the field. The control module 214 may then determine a corresponding requested change in the position of the base cutters 42 supported on the second lateral support bar 116B. In some instances, for example, the control module 214 may determine an average between the change in position of the center row divider 30 and the change in position of the right row divider 30, then control the first base cutter actuator 160A to adjust the position of the base cutters 42 by a second amount that corresponds to such average, with the second amount being determined using any suitable relationships (e.g., look up table(s)), algorithms, and/or the like. Thereafter, the control module 214 may monitor the change in the position of the base cutters 42 on the second lateral support bar 116B based at least in part on the data from the feedback sensor 162B to determine whether the base cutters 42 on the second lateral support bar 116B have moved by the requested second amount. If the change in the position of the base cutters 42 on the second lateral support bar 116B does not correspond to the second amount (or within a certain threshold of the second amount), then the control module 214 may generate a warning indicating a problem with the second base cutter actuator 160B.

It should be appreciated that the control module 214 may control the actuator(s) 160A, 160B based on any other suitable relationship between the positions of the corresponding row dividers 130. For instance, the control module 214 may control the actuator(s) 160A, 160B based on a differential between the positions of the associated row dividers 30 instead of, or in addition to, the average between the positions of the associated row dividers 30. Similarly, in some instances, the control module 214 may control the actuator(s) 160A, 160B based on a comparison of the positions of the associated row dividers 30 instead of, or in addition to, the average between the positions of the associated row dividers 30. For example, the control module 214 may control the actuator(s) 160A, 160B based on the higher of the associated row dividers 30 in the vertical direction V1. It should additionally be appreciated that, in some embodiments, a time delay may be provided between measuring the change in position of the row dividers 30 and controlling the base cutter actuator(s) 160A, 160B to account for the distance between the row dividers 30 and the base cutters 42 along the direction of travel DT1.

The control action may additionally, or alternatively, include controlling an operation of the user interface(s) 180 to generally indicate the positions of the row dividers 30 relative to the frame member 104, the contour of the surface of the field, recommended adjustments for the base cutters 42, a warning indicating a problem with the base cutter actuator(s) 160A, 160B, and/or the like.

Referring back to FIG. 4, the computing system(s) 202 may also include a communications interface 216 to provide a means for the computing system(s) 202 to communicate with any of the various system components described herein. For instance, one or more communicative links or interfaces (e.g., one or more data buses) may be provided between the communications interface 216 and the feedback sensor(s) 162A, 162B to allow feedback data transmitted from the feedback sensor(s) 162A, 162B to be received by the computing system(s) 202. Similarly, one or more communicative links or interfaces (e.g., one or more data buses) may be provided between the communications interface 216 and the row divider sensor(s) 164 to allow data transmitted from the row divider sensor(s) 164 to be received by the computing system(s) 202. Moreover, one or more communicative links or interfaces (e.g., one or more data buses) may be provided between the communications interface 216 and the position sensor(s) 170 to allow the position data transmitted from the position sensor(s) 170 to be received by the computing system(s) 202. Additionally, one or more communicative links or interfaces (e.g., one or more data buses) may be provided between the communications interface 216 and any system components configured to carry out one or more of the elements of the disclosed method. For example, as illustrated, the computing system(s) 202 may be communicatively coupled via one or more communicative links or interface(s) to the base cutter actuator(s) 160A, 160B, and the user interface(s) 180.

It should be appreciated that the computing system(s) 202 may correspond to an existing controller of the harvester 10. For instance, the computing device(s) 202 may correspond to a harvester controller of the harvester 10. However, the computing device(s) 202 may also correspond to a controller of one or more remote control devices separate from the harvester 10, such as part of a base station local to the field or part of a remote cloud-based computing system located remote to the field.

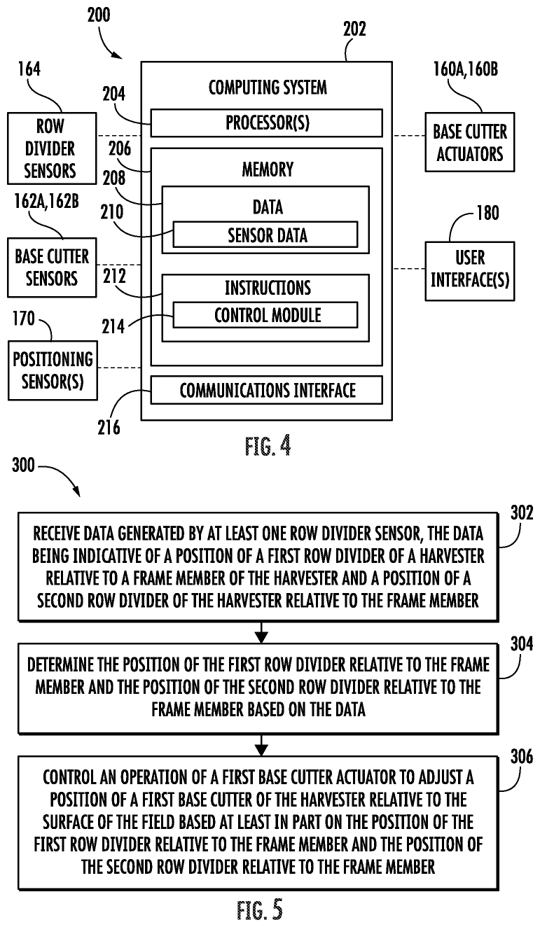

Referring now to FIG. 5, a flow diagram of one embodiment of a method 300 for adjusting a base cutter of an agricultural harvester is illustrated in accordance with aspects of the present subject matter. In general, the method 300 will be described herein with reference to the harvester 10 described with reference to FIGS. 1-3, and the system 200 described with reference to FIG. 4. However, it should be appreciated that the disclosed method 300 may be implemented with harvesters 10 having any other suitable configuration, and/or with systems having any other suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (302), the method 300 may include receiving data generated by at least one row divider sensor, the data being indicative of a position of a first row divider of a harvester relative to a frame member of the harvester and a position of a second row divider of the harvester relative to the frame member. For instance, as described above, the data generated by the row divider sensor(s) 164 may be received by the computing system 202, where the data is indicative of a position of a first row divider (e.g., the left row divider 30 in FIG. 2) of the harvester 10 relative to the frame member 104 and a position of a second row divider (e.g., the center row divider 30 in FIG. 2) of the harvester 10 relative to the frame member 104.

Further, at (304), the method 300 may include determining the position of the first row divider relative to the frame member and the position of the second row divider relative to the frame member based at least in part on the data. For example, as discussed above, the computing system 202 may determine the position of the left row divider 30 relative to the frame member 104 and the position of the center row divider 30 relative to the frame member 104 based at least in part on the data received from the row divider sensor(s) 164.

Additionally, at (306), the method 300 may include controlling an operation of a first base cutter actuator to adjust a position of a first base cutter of the harvester relative to the surface of the field based at least in part on the position of the first row divider relative to the frame member and the position of the second row divider relative to the frame member. For instance, as discussed above, the computing system 202 may control an operation of a first base cutter actuator 160A to adjust a position of a base cutter 42 positioned laterally between the left and center row dividers 30 (e.g., the base cutter(s) 42 supported on the first lateral support bar 116A) based at least in part on both the position of the left row divider 30 relative to the frame member 104 and the position of the center row divider 30 relative to the frame member 104.

It is to be understood that the steps of the method 300 are performed by the computing system 200 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 200 described herein, such as the method 300, is implemented in software code or instructions which are tangibly stored on a tangible computer readable medium. The computing system 200 loads the software code or instructions via a direct interface with the computer readable medium or via a wired and/or wireless network. Upon loading and executing such software code or instructions by the computing system 200, the computing system 200 may perform any of the functionality of the computing system 200 described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural system for adjusting a base cutter of an agricultural harvester, the agricultural system comprising:
a frame member;
a first row divider supported by the frame member relative to a surface of a field, the first row divider being movable relative to the frame member;
a second row divider supported by the frame member relative to the surface of the field, the second row divider being movable relative to the frame member independently of the first row divider, the second row divider being spaced apart from the first row divider in a lateral direction;
a first base cutter supported by the frame member relative to the surface of the field, the first base cutter being selectively movable relative to the frame member, the first base cutter being positioned between the first and second row dividers in the lateral direction;
a first base cutter actuator configured to selectively move the first base cutter relative to the frame member;
at least one divider sensor configured to generate data indicative of a position of the first row divider relative to the frame member and a position of the second row divider relative to the frame member,
a computing system configured to:
receive the data generated by the at least one divider sensor;
determine the position of the first row divider relative to the frame member and the position of the second row divider relative to the frame member based at least in part on the data generated by the at least one divider sensor; and
control an operation of the first base cutter actuator to adjust a position of the first base cutter relative to the surface of the field based at least in part on the position of the first row divider relative to the frame member and the position of the second row divider relative to the frame member.

2. The agricultural system of claim 1, wherein the computing system is configured to control the operation of the first base cutter actuator based at least in part on a comparison of the position of the first row divider relative to the frame member to the position of the second row divider relative to the frame member.

3. The agricultural system of claim 2, wherein the comparison of the position of the first row divider relative to the frame member to the position of the second row divider relative to the frame member comprises an average of the position of the first row divider relative to the frame member and the position of the second row divider relative to the frame member.

4. The agricultural system of claim 1, further comprising:
a third row divider supported by the frame member relative to the surface of the field, the third row divider being movable relative to the frame member independently of the first row divider and the second row divider, the third row divider being spaced apart from the second row divider in the lateral direction, the second row divider being between the first and third row dividers in the lateral direction;
a second base cutter supported by the frame member relative to the surface of the field, the second base cutter being selectively movable relative to the frame member, the second base cutter being positioned between the second and third row dividers in the lateral direction; and
a second base cutter actuator configured to selectively move the second base cutter relative to the frame member, independently of movement of the first base cutter relative to the frame member,
wherein the data generated by the at least one divider sensor is further indicative of a position of the third row divider relative to the frame member, and
wherein the computing system is further configured to:
determine the position of the third row divider relative to the frame member based at least in part on the data generated by the at least one divider sensor; and
control an operation of the second base cutter actuator to adjust a position of the second base cutter relative to the surface of the field based at least in part on the position of the third row divider relative to the frame member and the position of the second row divider relative to the frame member.

5. The agricultural system of claim 1, wherein the at least one divider sensor comprises a first divider sensor and a second divider sensor,
wherein the first divider sensor is coupled between the frame member and the first row divider, the first divider sensor being configured to determine a position of the first row divider relative to the frame member, the position of the first row divider relative to the frame member being indicative of the position of the first row divider relative to the frame member, and
wherein the second divider sensor is coupled between the frame member and the second row divider, the second divider sensor being configured to determine a position of the second row divider relative to the frame member, the position of the second row divider relative to the frame member being indicative of the position of the second row divider relative to the frame member.

6. The agricultural system of claim 5, wherein each of the first and second divider sensors comprises at least one of a linear position sensor or an angular position sensor.

7. The agricultural system of claim 1, wherein the first base cutter actuator is coupled between the first base cutter and the frame member.

8. The agricultural system of claim 1, wherein the first base cutter actuator is at least one of a linear actuator or a rotary actuator.

9. The agricultural system of claim 1, further comprising a feedback sensor configured to generate feedback data indicative of a position of the first base cutter relative to the frame member, the computing system being further configured to:
receive the feedback data generated by the feedback sensor;
determine the position of the first base cutter relative to the frame member based at least in part on the feedback data;
determine the position of the first base cutter relative to the surface of the field based at least in part on the position of the first base cutter relative to the frame member; and
determine whether the position of the first base cutter relative to the surface of the field corresponds to the positions of the first and second row dividers relative to the frame member.

10. The agricultural system of claim 9, wherein the feedback sensor comprises at least one of a linear position sensor or an angular position sensor.

11. An agricultural method for adjusting a base cutter of an agricultural harvester, the agricultural harvester comprising a frame member, a first row divider supported by the frame member relative to a surface of a field, a second row divider supported by the frame member relative to the surface of the field, the second row divider being movable relative to the frame member independently of the first row divider, the agricultural harvester further comprising a first base cutter supported by the frame member relative to the surface of the field, the first base cutter being positioned between the first and second row dividers in a lateral direction, the method comprising:
receiving, with a computing system, data generated by at least one divider sensor, the data being indicative of a position of the first row divider relative to the frame member and a position of the second row divider relative to the frame member;
determining, with the computing system, the position of the first row divider relative to the frame member and the position of the second row divider relative to the frame member based at least in part on the data; and
controlling, with the computing system, an operation of a first base cutter actuator to adjust a position of the first base cutter relative to the surface of the field based at least in part on the position of the first row divider relative to the frame member and the position of the second row divider relative to the frame member.

12. The agricultural method of claim 11, wherein controlling the operation of the first base cutter actuator comprises controlling the operation of the first base cutter actuator based at least in part on a comparison of the position of the first row divider relative to the frame member to the position of the second row divider relative to the frame member.

13. The agricultural method of claim 12, wherein the comparison of the position of the first row divider relative to the frame member to the position of the second row divider relative to the frame member comprises an average of the position of the first row divider relative to the frame member and the position of the second row divider relative to the frame member.

14. The agricultural method of claim 11, wherein the agricultural harvester further comprises:
a third row divider supported by the frame member relative to the surface of the field, the third row divider being movable relative to the frame member independently of the first row divider and the second row divider, the third row divider being spaced apart from the second row divider in the lateral direction, the second row divider being between the first and third row dividers in the lateral direction; and
a second base cutter supported by the frame member relative to the surface of the field, the second base cutter being selectively movable relative to the frame member, the second base cutter being positioned between the second and third row dividers in the lateral direction,
wherein the data generated by the at least one divider sensor is further indicative of a position of the third row divider relative to the frame member, and
wherein the method further comprises:
determining, with the computing system, the position of the third row divider relative to the frame member based at least in part on the data generated by the at least one divider sensor; and
controlling, with the computing system, an operation of a second base cutter actuator to adjust a position of the second base cutter relative to the surface of the field based at least in part on the position of the third row divider relative to the frame member and the position of the second row divider relative to the frame member.

15. The agricultural method of claim 11, wherein the at least one divider sensor comprises a first divider sensor and a second divider sensor,
wherein the first divider sensor is coupled between the frame member and the first row divider, the first divider sensor being configured to determine a position of the first row divider relative to the frame member, the position of the first row divider relative to the frame member being indicative of the position of the first row divider relative to the frame member, and
wherein the second divider sensor is coupled between the frame member and the second row divider, the second divider sensor being configured to determine a position of the second row divider relative to the frame member, the position of the second row divider relative to the frame member being indicative of the position of the second row divider relative to the frame member.

16. The agricultural method of claim 15, wherein each of the first and second divider sensors comprises at least one of a linear position sensor or an angular position sensor.

17. The agricultural method of claim 11, wherein the first base cutter actuator is coupled between the first base cutter and the frame member.

18. The agricultural method of claim 11, wherein the first base cutter actuator is at least one of a linear actuator or a rotary actuator.

19. The agricultural method of claim 11, further comprising:
receiving, with the computing system, feedback data generated by a feedback sensor, the feedback data being indicative of a position of the first base cutter relative to the frame member;
determining, with the computing system, the position of the first base cutter relative to the frame member based at least in part on the feedback data;
determining, with the computing system, the position of the first base cutter relative to the surface of the field based at least in part on the position of the first base cutter relative to the frame member; and
determining, with the computing system, whether the position of the first base cutter relative to the surface of the field corresponds to the positions of the first and second row dividers relative to the frame member.

20. The agricultural method of claim 19, wherein the feedback sensor comprises at least one of a linear position sensor or an angular position sensor.
